(19) United States
(12) Patent Application Publication
(10) Pub. No.: US 2026/0181086 A1
(43) Pub. Date: Jun. 25, 2026

(54) MEDIUM PROCESSING APPARATUS, IMAGE FORMING APPARATUS, AND IMAGE FORMING SYSTEM

(71) Applicant: Taketo KAWASHIMA, Gifu (JP)

(72) Inventor: Taketo KAWASHIMA, Gifu (JP)

(73) Assignee: ETRIA Co., Ltd., Kanagawa (JP)

(21) Appl. No.: 19/419,682

(22) Filed: Dec. 15, 2025

(30) Foreign Application Priority Data
Dec. 23, 2024 (JP) 2024-226712

(51) Int. Cl. H04N 1/00

(52) U.S. Cl. CPC H04N 1/0066; H04N 1/00602; H04N 1/00615; H04N 1/00618

(57) ABSTRACT

A medium processing apparatus includes a conveyor, a position changer, and circuitry. The conveyor conveys a sheet medium in a conveyance direction. The conveyor includes a roller pair having opposed rollers opposed to each other in a main scanning direction orthogonal to the conveyance direction. The roller pair nips an end portion of the sheet medium in the main scanning direction and convey the sheet medium in the conveyance direction. The position changer changes a position at which the roller pair nips the sheet medium to change an opposing distance between the opposed rollers of the roller pair in the main scanning direction. The circuitry is to control the conveyor and the position changer to change the opposing distance based on attribute information of the sheet medium.

### CROSS-REFERENCE TO RELATED APPLICATION

This patent application is based on and claims priority pursuant to 35 U.S.C. § 119(a) to Japanese Patent Application No. 2024-226712, filed on Dec. 23, 2024, in the Japan Patent Office, the entire disclosure of which is hereby incorporated by reference herein.

### BACKGROUND

### Technical Field

Embodiments of the present disclosure relate to a medium processing apparatus, an image forming apparatus, and an image forming system.

### Related Art

Medium processing apparatuses in the art are known that convey a sheet medium and perform a given operation on the sheet medium. In conveyance of a medium, such medium processing apparatuses in the art have a technique of guiding a part of the face of the medium to a position different from the position of a roller nipping portion of the medium to enhance the stiffness of the medium and restrain a curling of the leading end of the sheet medium, so that a stacking failure at ejection of a medium is eliminated.

In conveyance of a medium, a sheet ejection device in the art includes an ejection roller, a stiffness applier, a stiffness applier moving unit, and a medium information acquiring unit. The ejection roller ejects a medium after image formation. The stiffness applier applies the stiffness to a medium. The stiffness applier moving unit moves at least a pair of stiffness appliers in a direction orthogonal to a conveyance direction of the medium. The medium information acquiring unit acquires information of the medium.

The sheet ejection device in the art further includes a position change controller to change the moving position of the stiffness applier according to the result of acquisition by the medium information acquiring unit, so that the stiffness according to the sheet size and the sheet thickness can be applied.

When a process such as stacking the conveyed medium is performed, it is desirable to convey and eject the medium so as to increase the stiffness of the medium, in other words, to “strengthen the stiffness of the medium”. In a case where strong “stiffness” is required according to the medium size or the medium thickness, it is assumed that, according to the configuration of the sheet ejection device, for example, a method of increasing a pressing amount of the medium face to increase a stiffness imparting wave shape or a method of changing a stiffness imparting position to increase tension in a direction orthogonal to the conveyance direction of a medium.

In the technique in the art, in order to perform a strong stiffening, a load on the medium increases. For this reason, a large load may be required to impart suitable stiffness according to the properties of the medium using the technique in the art. As a result, a failure such as damage to the medium or deterioration of the quality of the medium face occurs. In other words, according to the technique in the art, a medium stiffness imparting increases the aggressiveness with respect to the medium face.

### SUMMARY

Embodiments of the present disclosure described herein provide a novel medium processing apparatus includes a conveyor, a position changer, and circuitry. The conveyor conveys a sheet medium in a conveyance direction. The conveyor includes a roller pair having opposed rollers opposed to each other in a main scanning direction orthogonal to the conveyance direction. The roller pair nips an end portion of the sheet medium in the main scanning direction and convey the sheet medium in the conveyance direction. The position changer changes a position at which the roller pair nips the sheet medium to change an opposing distance between the opposed rollers of the roller pair in the main scanning direction. The circuitry is to control the conveyor and the position changer to change the opposing distance based on attribute information of the sheet medium.

Further, embodiments of the present disclosure described herein provide an image forming apparatus including an image forming device to form an image on a sheet medium, and the above-described medium processing apparatus.

Further, embodiments of the present disclosure described herein provide an image forming system including an image forming apparatus to form an image on a sheet medium, and the above-described medium processing apparatus to perform a process on the sheet medium on which the image is formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to an embodiment of the present disclosure;

FIG. 2 is a block diagram illustrating a control configuration of the image forming system according to the present embodiment;

FIG. 3 is a block diagram illustrating a post-processing apparatus according to an embodiment of the present disclosure;

FIG. 4 is a diagram illustrating a hardware configuration of the post-processing apparatus;

FIG. 5 is a diagram illustrating a configuration of a medium conveying mechanism included in the post-processing apparatus;

FIG. 6 is a diagram illustrating a deskew operation on a medium in the medium conveying mechanism;

FIG. 7 is a diagram illustrating another deskew operation on a medium in the medium conveying mechanism;

FIG. 8 is a diagram illustrating a position changing operation of a conveyance roller pair in the medium conveying mechanism;

FIG. 9 is a diagram illustrating another position changing operation of a conveyance roller pair in the medium conveying mechanism;

FIG. 10 is a diagram illustrating yet another position changing operation of a conveyance roller pair in the medium conveying mechanism;

FIGS. 11A and 11B are diagrams illustrating a stiffness imparting operation on a medium in the medium conveying mechanism;

FIG. 12 is a diagram illustrating yet another position changing operation of a conveyance roller pair in the medium conveying mechanism;

FIG. 13 is a diagram illustrating a conveying operation in the medium conveying mechanism;

FIG. 14 is a diagram illustrating another position changing operation of a conveyance roller pair in the medium conveying mechanism;

FIG. 15 is a diagram illustrating yet another position changing operation of a conveyance roller pair in the medium conveying mechanism;

FIG. 16 is a flowchart of a conveyance control process of the post-processing apparatus; and

FIG. 17 is another flowchart of a conveyance control process of the post-processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### Embodiment of Image Forming System 1

A description is given below of an image forming system 1 according to an embodiment of the present disclosure, with reference to the drawings.

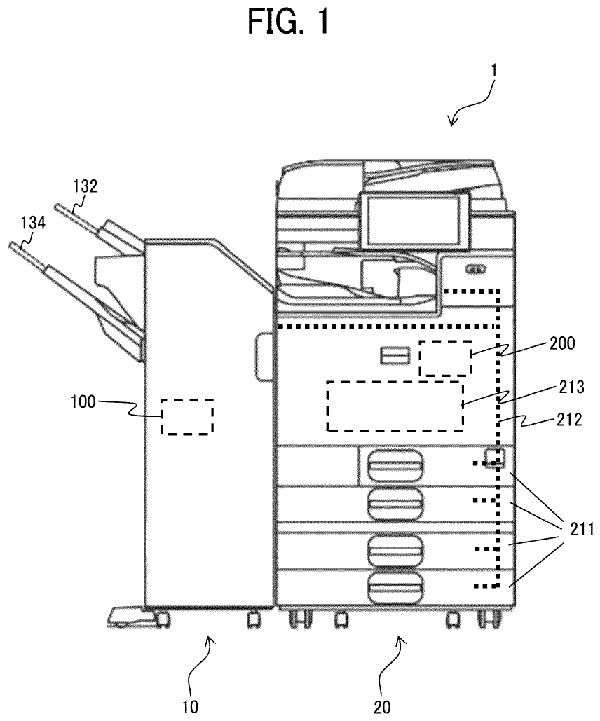

FIG. 1 is a diagram illustrating an overall configuration of the image forming system 1.

The image forming system 1 has a function of forming an image on a sheet P as a sheet medium and a function of performing a post-processing operation on the sheet P as a process after the image is formed on the sheet P.

As illustrated in FIG. 1, the image forming system 1 includes an image forming apparatus 20 including the image forming function and a post-processing apparatus 10 serving as a medium processing apparatus including the post-processing function, according to an embodiment of the present disclosure. In the image forming system 1, the image forming apparatus 20 and the post-processing apparatus 10 operate in conjunction with each other.

In the present embodiment, the sheet-shaped medium (sheet medium) to be processed in the image forming system 1 is assumed to be a sheet of “paper.” However, the object to be processed according to the present embodiment is not limited to a sheet of paper. For example, any material or specification may be used as long as an image can be formed on a medium in a known image forming process and the medium is a target of the image forming process. Examples of the medium include a medium that can be an object of a folding process or a binding process, and the material and specification of the medium are not limited to any particular material and specification.

The image forming apparatus 20 forms an image on the sheet P. The image forming apparatus 20 ejects the sheet P having the image on the sheet P to the post-processing apparatus 10. The image forming apparatus 20 includes a sheet tray 211 that accommodates the sheet P, a conveyor 212 that conveys the sheet P accommodated in the sheet tray 211, and an image forming device 213 that forms an image on the sheet P conveyed by the conveyor 212. The image forming device 213 may be an inkjet system that forms an image using ink or an electrophotographic system that forms an image using toner. The image forming apparatus 20 also includes an image formation controller 200 that controls various operations of the conveyor 212 and the image forming device 213. Since the image forming apparatus 20 has a typical configuration, a detailed description of the configuration and functions of the image forming apparatus 20 are omitted.

Sheets of paper are widely known as an example of sheet-shaped media. Further, in the following description, a sheet-shaped medium as a medium to be processed is referred to as a “sheet P.” Further, in the following description, a bundle of sheets of paper as a plurality of media is an example of a “sheet bundle Pb.”

The post-processing apparatus 10 performs designated post-processing operation on the sheet P ejected from the image forming apparatus 20. The sheet P subjected to the post-processing operation is appropriately ejected to the sheet ejection portion. The post-processing apparatus 10 is provided with multiple ejection destinations as ejection destinations selected according to the type of the post-processing operations. For example, the multiple ejection destinations includes an upper tray 132, a stapler tray 133, and a shift tray 134. The post-processing operations that can be performed in the post-processing apparatus 10 include, for example, a punching (punching operation) to punch the sheet P, an alignment operation to stack multiple sheets P and align the end portions of the multiple sheets P, and a binding operation to stack multiple sheets P and bind the end portions of the multiple sheets P to create a sheet bundle Pb.

In the embodiment of the post-processing apparatus 10 described below, although a specific post-processing operation is not mentioned, it is assumed that an operation of performing at least one of the above-described post-processing operations and a conveyance control that is described below are is performed.

### Control Configuration of Image Forming System 1

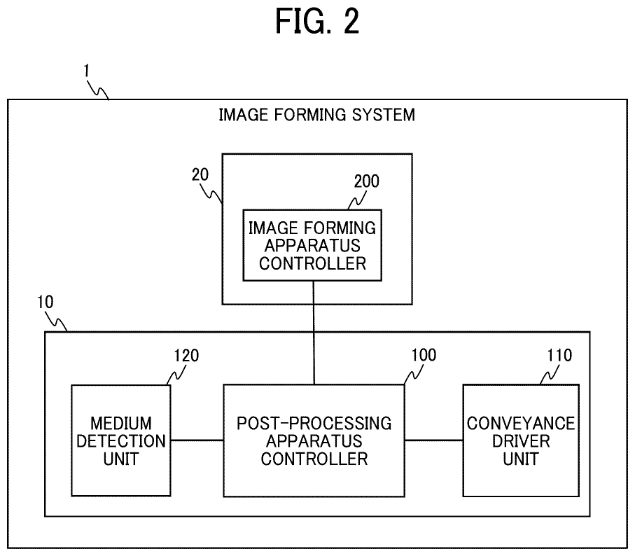

A description is given of the control configuration that controls the operations of the image forming system 1, with reference to the block diagram of FIG. 2.

FIG. 2 is a block diagram illustrating a control configuration of the image forming system 1 according to the present embodiment.

As illustrated in FIG. 2, the image forming apparatus 20 includes an image formation controller 200 and the post-processing apparatus 10 includes a post-processing controller 100. The image formation controller 200 of the image forming apparatus 20 and the post-processing controller 100 of the post-processing apparatus 10 are communicably connected to each other. The post-processing apparatus 10 includes the post-processing controller 100, a conveyor driver 110, and a medium detector 120. The post-post-processing controller 100 is connected to the image forming apparatus 20, and is also connected to conveyor driver 110 and the medium detector 120 of the post-processing apparatus 10 so as to be able to communicate with each other.

The conveyor driver 110 includes, for example, a motor that drives a conveyance roller pair that conveys the sheet P, and a motor that moves the conveyance roller pair to change a position where the conveyance roller pair contacts the sheet P.

The medium detector 120 includes, for example, a sensor to detect that the sheet P ejected from the image forming apparatus 20 is conveyed into the post-processing apparatus 10, a sensor to detect a position at which the sheet P is conveyed in a conveyance path of the post-processing apparatus 10, and a sensor to detect a position of a constituent member of a mechanism for enabling a position of each mechanism (described below) to be determined.

### Control Configuration of Post-Processing Apparatus 10

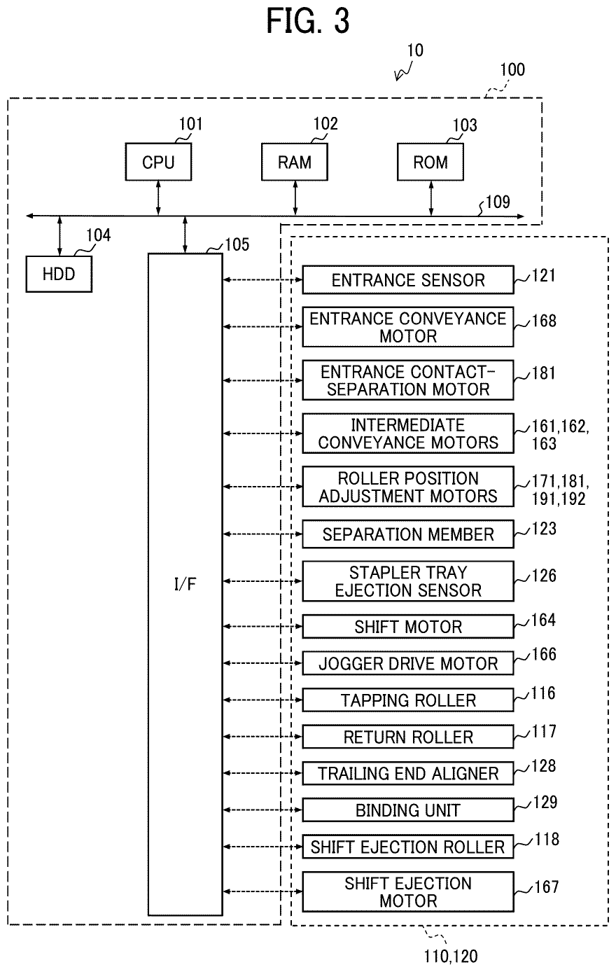

A description is given of the control configuration that controls the operations of the post-processing apparatus 10, with reference to the block diagram of FIG. 3.

FIG. 3 is a block diagram illustrating a post-processing apparatus 10 according to an embodiment of the present disclosure.

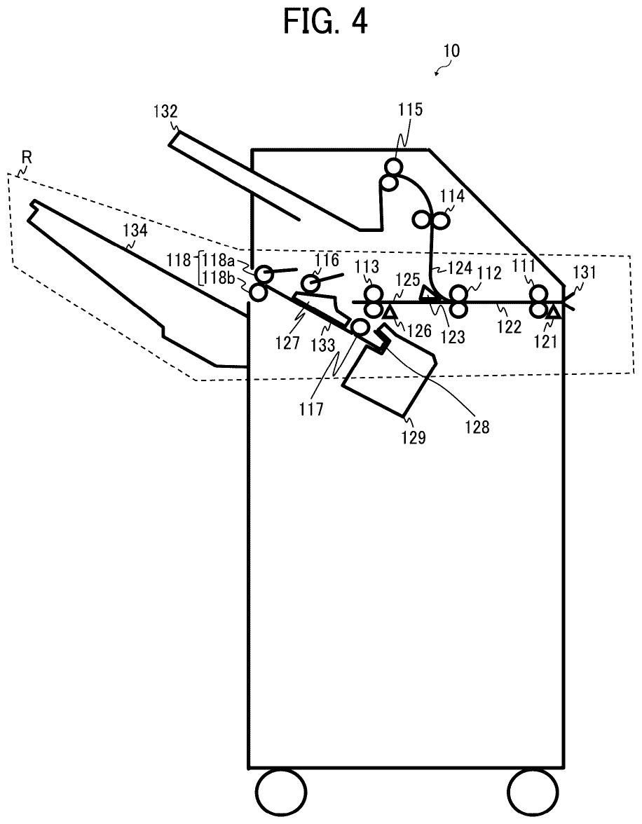

In FIG. 3, reference numerals given to the respective units included in the conveyor driver 110 and the medium detector 120 correspond to the contents illustrated in FIG. 4.

The post-processing apparatus 10 includes a central processing unit (CPU) 101, a random access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 10.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 10 processes, for example, a control program stored in the ROM 103 and an information processing program (application program) loaded into the RAM 102 from a storage medium such as the HDD 104. Such processing configures a software controller including various functional modules of the post-processing apparatus 10. The software controller thus configured cooperates with hardware resources of the post-processing apparatus 10 to construct functional blocks that implement functions of the post-processing apparatus 10. In other words, the CPU 101, the RAM 102, the ROM 103, the HDD 104, and the I/F 105 are included the post-processing controller 100 (controller) that controls the operations of the post-processing apparatus 10.

The I/F 105 is an interface that connects an entrance sensor 121, an entrance conveyance motor 168, a first intermediate conveyance motor 161, a second intermediate conveyance motor 162, a third intermediate conveyance motor 163, a first roller position change motor 171, a second roller position change motor 181, a third roller position change motor 191, a separation member 123, a stapler tray ejection sensor 126, a shift motor 164, a jogger drive motor 166, a tapping roller 116, a return roller 117, a trailing end aligner 128, a binding unit 129, a shift ejection roller pair 118, and a shift ejection motor 167, to the common bus 109.

The entrance conveyance motor 168 drives the entrance conveyance roller pair 111. The first intermediate conveyance motor 161 drives the intermediate conveyance roller 112. The second intermediate conveyance motor 162 drives the shift roller 113. The third intermediate conveyance motor 163 drives an upper conveyance roller 114.

The shift motor 164 drives the shift roller 113. The jogger drive motor 166 is a drive source that moves the jogger 127. The shift ejection motor 167 drives the shift ejection roller pair 118.

The first roller position change motor 171 operates a first scotch yoke mechanism 170 for changing a position where the entrance conveyance roller pair 111 nips the medium. The second roller position change motor 181 operates a second scotch yoke mechanism 180 for changing a position where the intermediate conveyance roller 112 and the shift roller 113 nip the medium. The third roller position change motor 191 operates a third scotch yoke mechanism 190 for changing a position at which the shift ejection roller pair 118 nips the medium.

The post-processing controller 100 controls the operations of the entrance conveyance motor 168, the first intermediate conveyance motor 161, the second intermediate conveyance motor 162, the third intermediate conveyance motor 163, the first roller position change motor 171, the second roller position change motor 181, the third roller position change motor 191, the separation member 123, the shift motor 164, the jogger drive motor 166, the tapping roller 116, the return roller 117, the trailing end aligner 128, the binding unit 129, the shift ejection roller pair 118, and the shift ejection motor 167, via the I/F 105. In addition, the post-processing controller 100 acquires detection results of the entrance sensor 121 and the stapler tray ejection sensor 126.

As described above, the post-processing apparatus 10 implements a function of performing operation control related to the conveyance of the sheet P to the post-processing controller 100 by software (control programs) executed by the CPU 101 with hardware resources included in the post-processing controller 100.

### Embodiment of Post-Processing Apparatus 10

A description is given below of the configuration of the post-processing apparatus 10 according to the present embodiment, with reference to FIG. 4.

FIG. 4 is a diagram illustrating a hardware configuration of the post-processing apparatus 10.

Of the configurations of the post-processing apparatus 10, FIG. 4 illustrates the configuration of the part closely related to an embodiment of the present disclosure.

After being ejected from the image forming apparatus 20 and conveyed to the post-processing apparatus 10, the sheet P is received by the entrance guide 131 and conveyed along the entrance conveyance path 122 by the entrance conveyance roller pair 111 and the intermediate conveyance roller pair 112. Then, the sheet P is further conveyed to the upper conveyance path 124 or the horizontal conveyance path 125 depending on the position of the separation member 123. In other words, the separation member 123 corresponds to a switcher that switches the conveyance direction of the sheet P.

After having been conveyed to the upper conveyance path 124, the sheet P is ejected by the conveying operations by the upper conveyance roller 114 and the upper ejection roller 115 to the upper tray 132 and stacked on the upper tray 132. The sheet P conveyed to the horizontal conveyance path 125 is ejected from the horizontal conveyance path 125 by the conveying operations by the shift roller pair 113 and the shift ejection roller pair 118 and is stacked on the shift tray 134. The sheet P ejected from the horizontal conveyance path 125 may be conveyed to and stacked on the stapler tray 133 by the operation of the tapping roller 116. The stapler tray 133 is provided with an alignment mechanism including the trailing end aligner 128 and the jogger 127. The alignment mechanism performs the alignment operation on the end portions, with a given number of sheets P is stacked on the stapler tray 133. After this operation, the binding unit 129 performs a binding operation that is an example of a given process. The sheet bundle Pb subjected to the binding operation is ejected to the shift tray 134.

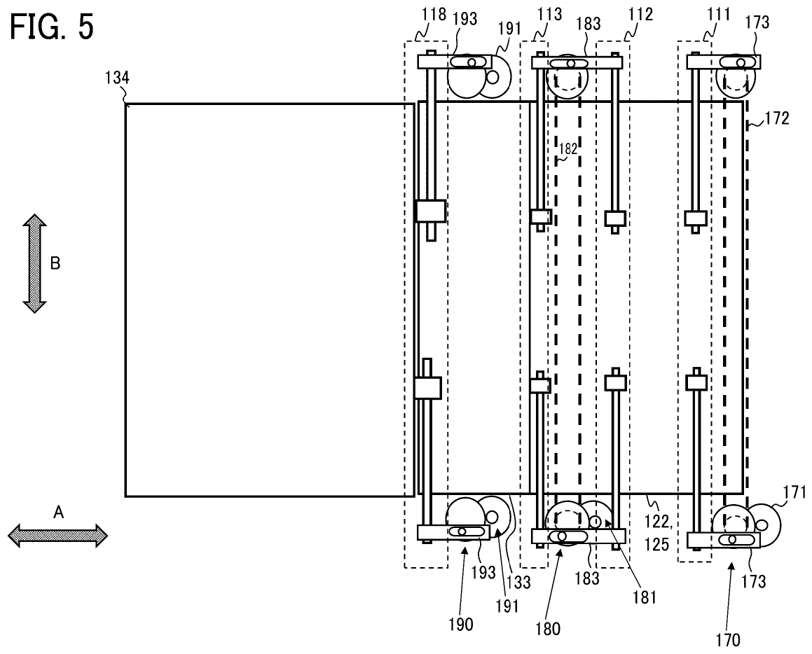

FIG. 5 is a diagram illustrating a configuration of a medium conveying mechanism included in the post-processing apparatus 10.

To be more specific, FIG. 5 illustrates a region R surrounded by a dotted line in FIG. 4, viewed from the upper face side.

The direction indicated by arrow A in FIG. 5 indicates the conveyance direction of the sheet P. The direction indicated by arrow B in FIG. 5 is a direction orthogonal to the conveyance direction of the sheet P. The direction indicated by arrow B may be referred to as a “main scanning direction.”

As illustrated in FIG. 5, the entrance conveyance roller pair 111, the intermediate conveyance roller pair 112, the shift roller pair 113, and the shift ejection roller pair 118 each function as a conveyor and are provided so that the respective rotation axes are parallel to the main scanning direction. Each of the entrance conveyance roller pair 111, the intermediate conveyance roller pair 112, the shift roller pair 113, and an upper shift ejection roller 118a is a roller pair having rollers opposite to each other in the main scanning direction. To be more specific, each roller pair has rollers disposed in a direction orthogonal to the conveyance direction and the main scanning direction, in other words, rollers in pair in the vertical direction with the post-processing apparatus 10 installed in a standing state, so that the rollers of the roller pair can nip the sheet P. The roller pairs are arranged at positions with a given interval in the conveyance direction.

Each of the entrance conveyance roller pair 111, the intermediate conveyance roller pair 112, the shift roller pair 113, and the shift ejection roller pair 118 includes a roller pair facing each other in the main scanning direction. The roller pairs is driven to rotate by a motor whose operation is controlled by the post-processing controller 100.

A gap is provided between each roller pair of the entrance conveyance roller pair 111, the intermediate conveyance roller pair 112, the shift roller pair 113, and the shift ejection roller pair 118 in the main scanning direction. In other words, each of the entrance conveyance roller pair 111, the intermediate conveyance roller pair 112, the shift roller pair 113, and the shift ejection roller pair 118 has the rollers in pair in the main scanning direction so as to be line-symmetrical with respect to a center line of the width of the conveyance path of the sheet P as a symmetry axis.

The entrance conveyance roller pair 111 is fixed to the first scotch yoke mechanism 170 that can change a separation width between the roller pair with the center line of the width of the conveyance path as a target axis. The first scotch yoke mechanism 170 includes the first roller position change motor 171, a first transmission belt 172 that transmits a rotation of the first roller position change motor 171, and first crank pins 173 that are rotated by the first transmission belt 172. The rollers of the entrance conveyance roller pair 111 are disposed facing the bearings of the first crank pins 173, and are fixed to the respective bearings of the first crank pins 173.

The first scotch yoke mechanism 170 shifts the positions of the first crank pins 173 disposed facing each other by 180 degrees around the rotation axis. In other words, when the rotation of the first roller position change motor 171 is transmitted by the first transmission belt 172 to rotate the first crank pins 173, the position of each of the bearings of the first crank pins 173 moves in the main scanning direction, and thus the entrance conveyance roller pair 111 fixed to the bearings of the first crank pins 173 moves in a direction in which the entrance conveyance rollers relatively approach or separate from each other.

The first scotch yoke mechanism 170 as a conveyance position changer causes the entrance conveyance roller pair 111 to change the width of the roller pair in the main scanning direction.

The intermediate conveyance roller pair 112 and the shift roller pair 113 are fixed to the second scotch yoke mechanism 180 that can change a separation width between the rollers in pair with the center line of the width of the conveyance path as a target axis. The second scotch yoke mechanism 180 includes the second roller position change motor 181, a second transmission belt 182 that transmits a rotation of the second roller position change motor 181, and second crank pins 183 that are rotated by the second transmission belt 182. The rollers of the intermediate conveyance roller pair 112 and the rollers of the shift roller pair 113 are disposed facing each other, and are fixed to the respective bearings of the second crank pins 183.

The second scotch yoke mechanism 180 shifts the positions of the second crank pins 183 disposed facing each other by 180 degrees around the rotation axis. In other words, when the rotation of the second roller position change motor 181 is transmitted by the second transmission belt 182 to rotate the second crank pins 183, the position of each of the bearings of the second crank pins 183 moves in the main scanning direction, and thus the intermediate conveyance roller pair 112 and the shift roller pair 113 fixed to the bearings of the second crank pins 183 moves in a direction in which the intermediate conveyance roller pair 112 and the shift roller pair 113 relatively approach or separate from each other.

The second scotch yoke mechanism 180 as a conveyance position changer causes the intermediate conveyance roller pair 112 and the shift roller pair 113 to change the width of the roller pair in the main scanning direction.

The shift ejection roller pair 118 is fixed to the third scotch yoke mechanism 190 that can change a separation width between the roller pair with the center line of the width of the conveyance path as a target axis. The third scotch yoke mechanism 190 includes the third roller position change motor 191, and third crank pins 193 that are rotated by the third roller position change motor 191. The rollers of the shift ejection roller pair 118 disposed facing each other are fixed to the bearings of the third crank pins 193.

In the third scotch yoke mechanism 190, as the rotation of each of the third crank pins 193 is transmitted to rotate the third roller position change motor 191, the position of each of the bearings of the third crank pins 193 moves in the main scanning direction. Thus, each of the rollers of the shift ejection roller pair 118 fixed to the bearings of the third crank pins 193 moves in a direction in which the shift ejection roller pair 118 relatively approach or separate from each other.

### Example of Deskew Operation According to Present Embodiment

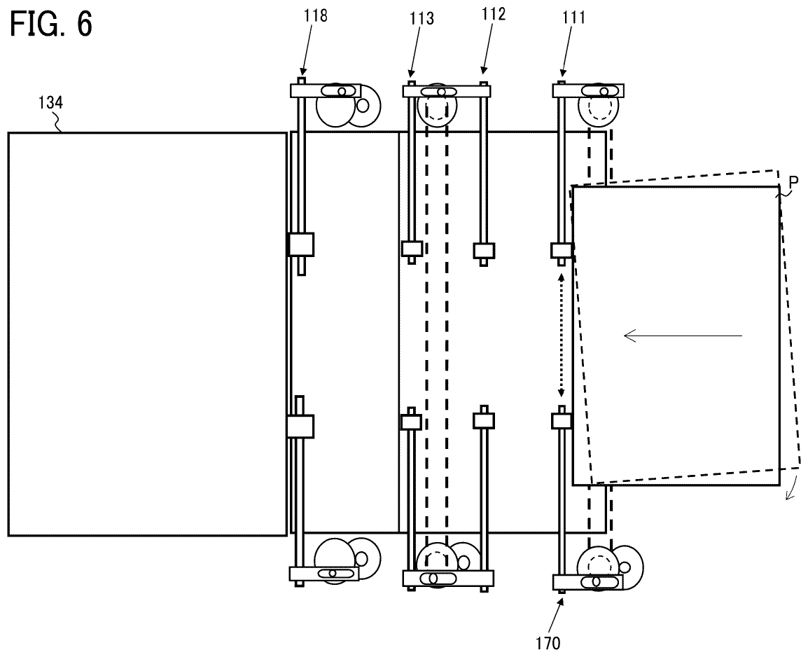

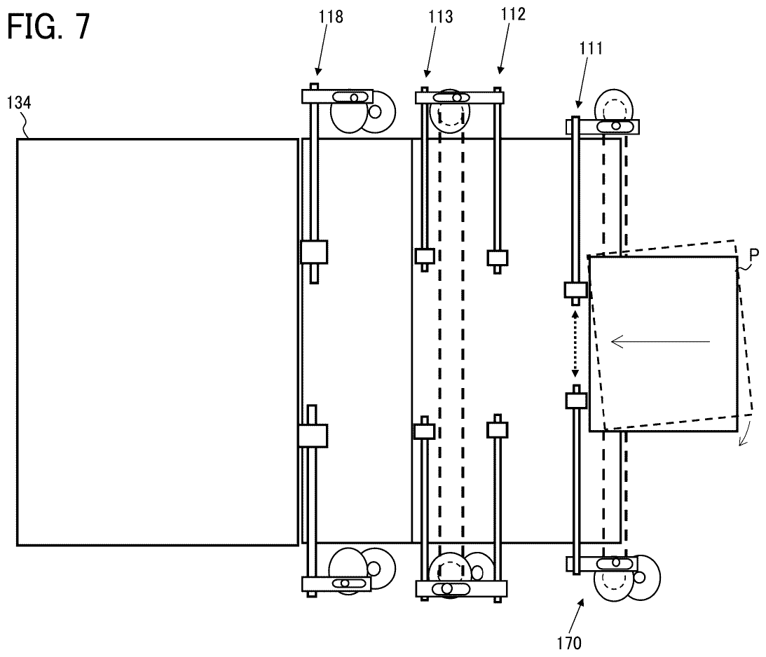

A description is given below of an example of a deskew operation with respect to the sheet P ejected by the image forming apparatus 20, in the post-processing apparatus 10 according to the present embodiment, with reference to FIGS. 6 and 7.

FIG. 6 is a diagram illustrating a deskew operation on a medium in the medium conveying mechanism. To be more specific, FIG. 6 illustrates an example in which the size of the sheet P is relatively large.

FIG. 7 is a diagram illustrating another deskew operation on a medium in the medium conveying mechanism. To be more specific, FIG. 7 illustrates an example in which the size of the sheet P is relatively small.

The “large sheet P” and the “small sheet P” illustrated in FIGS. 6 and 7 do not limit the specific size of the sheet P, and are expressions used for comparison for description.

As illustrated in FIGS. 6 and 7, the width of the rollers of the entrance conveyance roller pair 111 is changeable between the rollers with the center in the direction of the conveyance path width of the sheet P as a target axis. The roller width is determined based on the sheet size information notified (output) from the image forming apparatus 20 to the post-processing apparatus 10. In other words, the post-processing controller 100 of the post-processing apparatus 10 receives the sheet size information from the image formation controller 200 of the image forming apparatus 20 via the interface.

Then, based on the sheet size information received from the image formation controller 200 of the image forming apparatus 20, the post-processing controller 100 calculates a timing at which the downstream end of the sheet P in the conveyance direction contacts the entrance conveyance roller pair 111. After the downstream end of the sheet P in the conveyance direction contacts the entrance conveyance roller pair 111 at the timing calculated by the post-processing controller 100, the conveying operation by the entrance conveyance roller pair 111 is stopped. Further, the conveying operation performed by the conveyance roller pairs disposed upstream from the entrance conveyance roller pair 111 in the conveyance direction is continued. As described above, for example, by causing the portion near the end portion of the sheet P in the width direction and the end portion of the sheet Pin the conveyance direction to the entrance conveyance roller pair 111, the deskew operation to correct skew of the sheet P can be performed.

The accuracy of the deskew varies depending on which position in the main scanning direction the entrance conveyance roller pair 111 contacts the downstream end of the sheet P in the conveyance direction. In response to this action, the post-processing controller 100 adjusts the interval between the rollers of the entrance conveyance roller pair 111 based on the size of the sheet P included in the attribute information of the sheet P received from an apparatus upstream from the post-processing apparatus 10 in the conveyance direction of the sheet P. The interval between the rollers of the entrance conveyance roller pair 111 in the main scanning direction in this case are the positions where the rollers can contact near the end portions of the sheet P to be conveyed.

In other words, the entrance conveyance roller pair 111 is moved to a position where the sheet P is easily rotated in a direction in which the skew of the sheet P is deskewed by causing the rollers of the entrance conveyance roller pair 111 to contact the portion near the end portions of the sheet P in the width direction.

Typically, since the interval between the rollers of the entrance conveyance roller pair 111 in the main scanning direction is fixed, the width and the number of the entrance conveyance roller pair 111 were to be increased in order to enhance the accuracy in deskew operation for various sheet sizes. However, by increasing the width and the number of rollers, the contact area with the sheet P increases, and the image region becomes more likely to be damaged. In the present embodiment, the interval between the rollers of the entrance conveyance roller pair 111 in the main scanning direction is made controllable without increasing the width or the number of the rollers of the entrance conveyance roller pair 111, and the contact position on the roller is changed for each sheet size. By so doing, the accuracy in deskew of a sheet can be enhanced.

In other words, the multiple conveyors includes multiple roller pairs such as the entrance conveyance roller pair 111, the intermediate conveyance roller pair 112, the shift roller pair 113, and the shift ejection roller pair 118 and are arranged in different positions in the conveyance direction. The multiple roller pairs include a first roller pair, and a second roller pair upstream from the first roller pair in the conveyance direction. The post-processing controller 100 of the post-processing apparatus 10 stops the first roller pair at a timing when the sheet P contacts the first roller pair while driving the second roller pair, and sets a distance between the opposed rollers of the first roller pair based on the attribute information.

### Example of Conveying Operation According to Present Embodiment

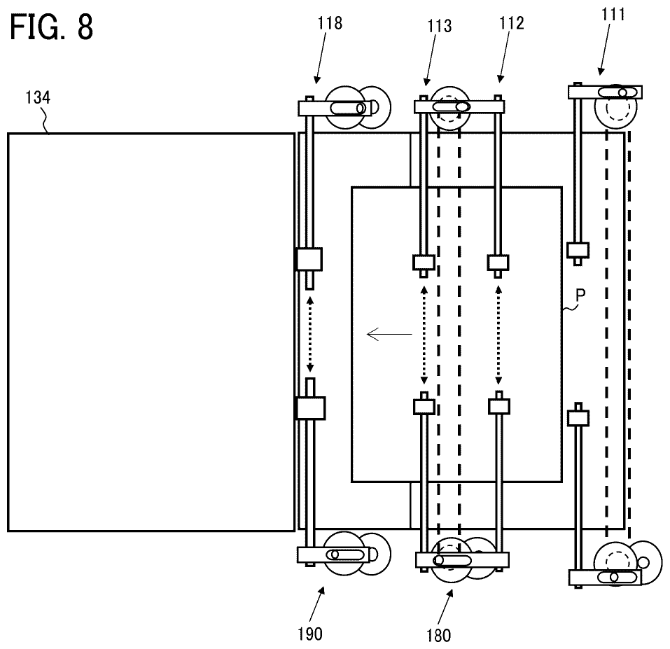

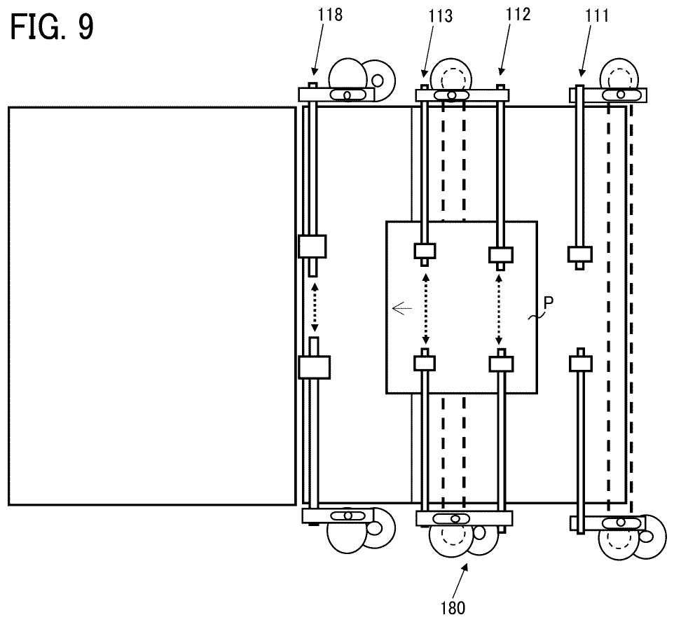

A description is given below of an example of a conveying operation with respect to the sheet P ejected by the image forming apparatus 20, in the post-processing apparatus 10 according to the present embodiment, with reference to FIGS. 8 and 9.

FIG. 8 is a diagram illustrating a position changing operation of a conveyance roller pair in the medium conveying mechanism. FIG. 8 illustrates an example in a case where the size of the sheet P in the main scanning direction is relatively long.

FIG. 9 is a diagram illustrating another position changing operation of a conveyance roller pair in the medium conveying mechanism. FIG. 9 illustrates an example in a case where the size of the sheet P in the main scanning direction is relatively short.

The “large sheet P in the main scanning direction” and the “small sheet P in the main scanning direction” illustrated in FIGS. 8 and 9 do not limit the specific size of the sheet P, and are expressions used for comparison for description.

As illustrated in FIG. 8, in a case where the sheet P having a size relatively long in the main scanning direction is conveyed, the second scotch yoke mechanism 180 and the third scotch yoke mechanism 190 are operated based on the attribute information received by the post-processing controller 100 of the post-processing apparatus 10 from the image forming apparatus 20. Due to such a configuration, the intervals between the opposite rollers of the intermediate conveyance roller pair 112, the shift roller pair 113, and the shift ejection roller pair 118 are increased. By increasing the interval between the rollers, the sheet P can be nipped at a suitable position near the end portion of the sheet P in the width direction. In other words, the sheet P can be conveyed at a position corresponding to the size of the sheet P based on the sheet size information included in the attribute information of the sheet P.

As illustrated in FIG. 9, in a case where the sheet P having a size relatively short in the main scanning direction is conveyed, the second scotch yoke mechanism 180 and the third scotch yoke mechanism 190 are operated based on the attribute information received by the post-processing controller 100 of the post-processing apparatus 10 from the image forming apparatus 20. Due to such a configuration, the intervals between the opposite rollers of the intermediate conveyance roller pair 112, the shift roller pair 113, and the shift ejection roller pair 118 are decreased. By decreasing the interval between the rollers, the sheet P can be nipped at a suitable position near the end portion of the sheet P in the width direction. In other words, the sheet P can be conveyed at a position corresponding to the size of the sheet P based on the sheet size information included in the attribute information of the sheet P.

### Example of Stiffness Imparting According to Present Embodiment

A description is given below of an example of a stiffness imparting on the sheet P ejected by the image forming apparatus 20, in the post-processing apparatus 10 according to the present embodiment.

The term “stiffness imparting” or “stiffening” in the present embodiment refers to an operation of increasing the stiffness of the sheet P by bending the sheet P in the conveyance direction when the sheet P is conveyed and ejected to, for example, the shift tray 134. By increasing the stiffness of the sheet P, the posture of the sheet P is prevented from being disturbed when the sheet P is ejected to the shift tray 134. As a result, the alignment of the sheet P can be enhanced.

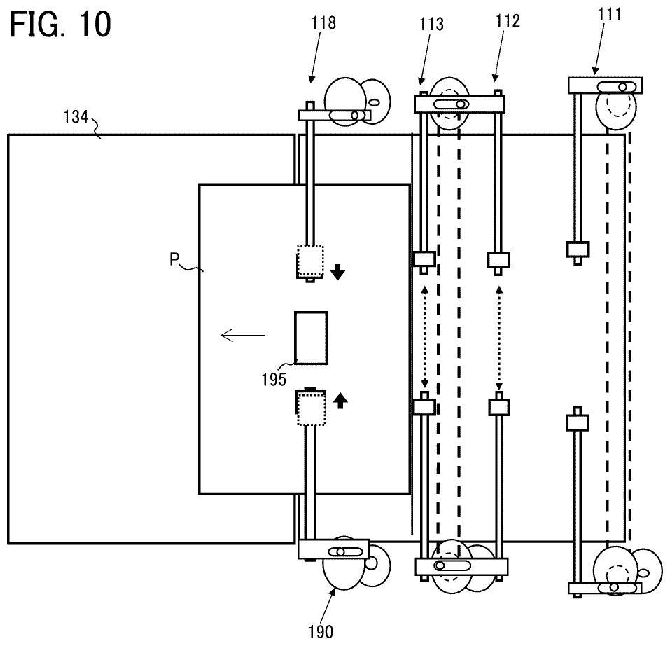

FIG. 10 is a diagram illustrating yet another position changing operation of a conveyance roller pair in the medium conveying mechanism.

As illustrated in FIG. 10, the post-processing controller 100 determines the conveyance position of the sheet P and determines the timing at which the trailing end of the sheet P passes through the shift roller pair 113. After the trailing end of the sheet P passes through the shift roller 113, the post-processing controller 100 causes the third scotch yoke mechanism 190 to move the shift ejection roller pair 118 in a direction in which the interval in the main scanning direction between the opposite rollers of the shift ejection roller pair 118 is narrowed. Due to this operation of the shift ejection roller pair 118, the sheet P is pushed in a direction in which the portions of the sheet P in contact with the shift ejection roller pair 118 are opposed and approach. In other words, a part of the sheet P moves toward the vicinity of the center of the sheet P in the direction (main scanning direction) orthogonal to the conveyance direction of the sheet P. As a result, the sheet P is bent, and the stiffness of the sheet P can be increased.

In a case where the leading end of the sheet P hangs down when the sheet P is ejected, the leading end of the sheet P is caught on the stacking face of the shift tray 134, and the end portion of the sheet P is rounded. As a result, a stacking failure occurs. In the post-processing apparatus 10 according to the present embodiment, by performing the operation of increasing the stiffness (stiffness imparting) at the time of ejection of a sheet P, the leading end of the sheet P can be prevented from hanging down when the sheet P is stacked on the shift tray 134, and a stacking failure can be prevented from occurring.

The post-processing apparatus 10 includes a stiffness imparting guide 195 as a bending guide that restricts a bending direction of the sheet P.

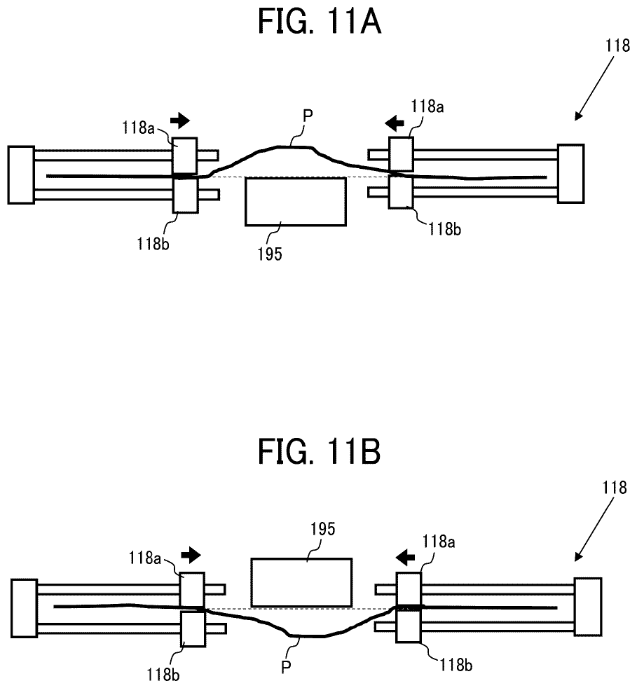

FIGS. 11A and 11B are diagrams illustrating a stiffness imparting operation on the sheet P in the medium conveying mechanism, viewed from the ejection direction of the sheet P.

As illustrated in FIGS. 11A and 11B, the stiffness imparting guide 195 is on one side or the other side, that is, the opposite side to the one side, across the face of the sheet P to be ejected. As illustrated in FIG. 11A, when the stiffness imparting guide 195 is disposed below the sheet P (one side or first side), the bending direction of the sheet P is upward (to the other side or second side). Further, as illustrated in FIG. 11Bb, when the stiffness imparting guide 195 is disposed above the sheet P (the other side or second side), the bending direction of the sheet P is downward (to the one side or first side).

In other words, the stiffness imparting guide 195 (as a bending guide) bends the sheet P in one direction of a vertical direction to increase the stiffness of the sheet P. The stiffness imparting guide 195 is disposed on one of an upper side or a lower side, across a conveyance plane to convey the sheet P, in the vertical direction. The post-processing controller 100 of the post-processing apparatus 10 controls the position changer (e.g., the third scotch yoke mechanism 190) to decrease the opposing distance to bend the sheet medium in another of the upper side or the lower side of the conveyance plane opposite to a position of the stiffness imparting guide 195 in the vertical direction.

As illustrated in FIGS. 11A and 11B, the shift ejection roller pair 118 nips the sheet P between the upper shift ejection roller 118a and a lower shift ejection roller 118b. The third scotch yoke mechanism 190 causes the shift ejection roller pair 118 to move in the main scanning direction while the upper shift ejection roller 118a and the lower shift ejection roller 118b nip the given position of the sheet P. By so doing, the sheet P can be bent.

In a case that it is assumed that the stiffness imparting guide 195 is not disposed, the sheet P may be bent upward or downward. This unexpectable movement of the sheet P is likely to cause an unexpected stacking failure. In order to address this inconvenience, the post-processing apparatus 10 according to the present embodiment includes the stiffness imparting guide 195, so that the direction to bend the sheet P is determined and the sheets P can be stacked with the stable quality.

In addition, the sheet guide face is provided below the roller nipping face in the bending direction in which the sheet P is bent. Further, the stiffening guide 195 is provided only on one side, that is, the stiffness imparting guide 195 is not on both sides of the sheet P at the same time. Since the bent amount of the sheet P changes depending on the shift amount of the shift ejection roller pair 118, the bent amount of the sheet P can be controlled according to the sheet type. For example, when there are a thin paper and a thick paper of the same size, the thin paper is more likely to cause the leading end to be rounded, and thus requires a strong stiffness. In this case, the stiffening amount applied by the shift ejection roller pair 118 can be increased during the conveyance of the thin paper as compared with the conveyance of the thick paper.

Example of Shift Operation after Stiffness Imparting According to Present Embodiment

A description is given below of an example of a shift operation after stiffness imparting on the sheet P ejected by the image forming apparatus 20, in the post-processing apparatus 10 according to the present embodiment.

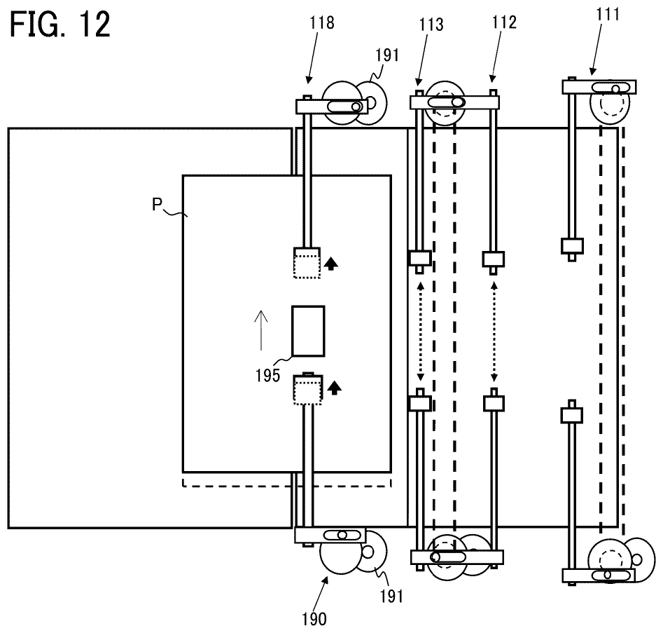

FIG. 12 is a diagram illustrating yet another position changing operation of a conveyance roller pair in the medium conveying mechanism.

As illustrated in FIG. 12, the shift ejection roller pair 118 as a shift conveyance roller pair includes third roller position change motors 191 disposed opposite to each other to operate separately in the third scotch yoke mechanism 190 that changes the positions of the opposed rollers in the main scanning direction. Since the third roller position change motors 191 separately controlled, the rollers in pair of the shift ejection roller pair 118 are movable in separate directions by the individual amount of movement.

For the above reasons, the shift ejection roller pair 118 can not only change the distance between the rollers facing each other but also perform shift conveyance while keeping the constant width between the rollers.

By shifting the sheet P, the sheet P can be sorted when the sheet P is stacked on the stacker, and the convenience can be enhanced. Further, even in a state where the sheet P is shifted, the stiffness imparting with the center of the sheet as illustrated in FIGS. 11A and 11B can be performed, and thus the risk of stacking failure at the time of shift stacking can be reduced.

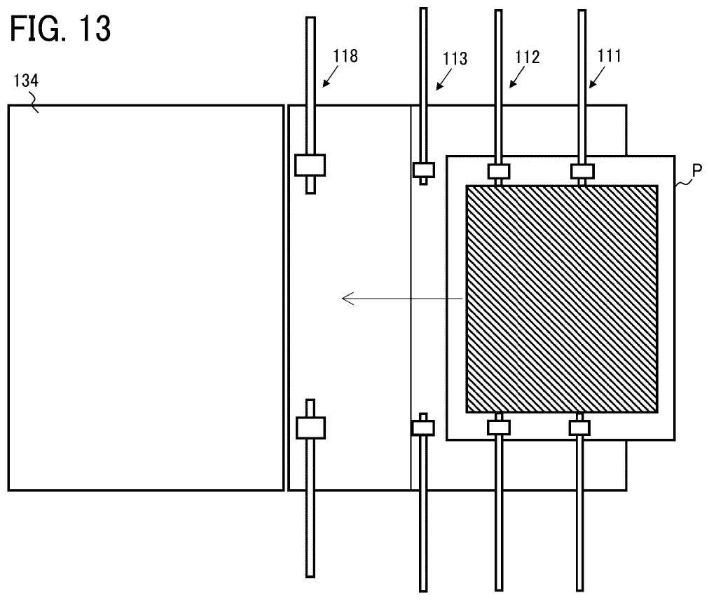

FIG. 13 is a diagram illustrating a conveying operation in the medium conveying mechanism. To be more specific, FIG. 13 illustrates a state of sheet conveyance in which the rollers are pressed on the outside of the image forming area.

In the above-described operations, when the rollers are moved in the main scanning direction, the sheet P can be conveyed without pressing the rollers against the image forming area in the sheet conveyance with reference to the intermediate position (center) of the dimension of the sheet P in the width direction. In FIG. 13, a hatched rectangular area superimposed on the sheet P indicates a position of the image forming area.

### First Modification of Shift Ejection Roller Pair 118 According to Present Embodiment

A description is given of a first modification of the conveyance position changer that changes the position of the shift ejection roller pair 118 in the main scanning direction.

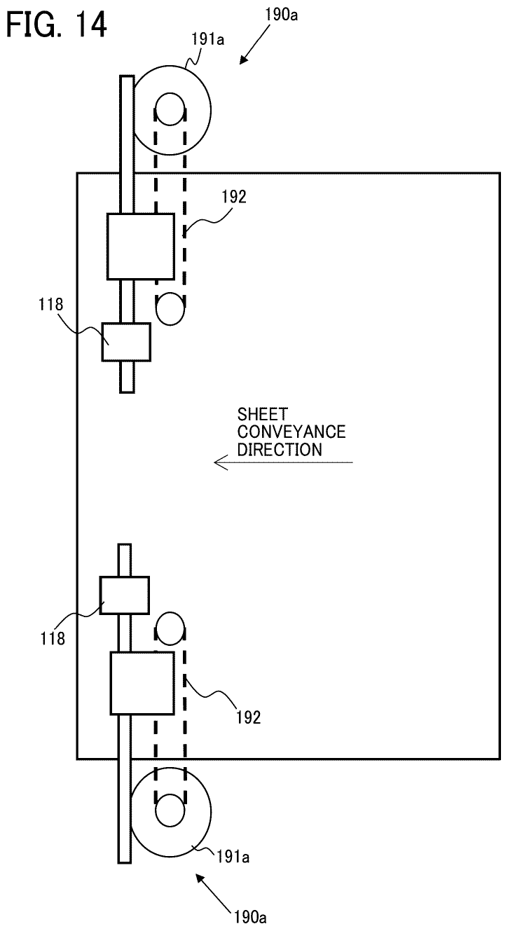

FIG. 14 is a diagram illustrating another position changing operation of a conveyance roller pair in the medium conveying mechanism. To be more specific, FIG. 14 illustrates a third scotch yoke mechanism 190a according to the first modification.

The third scotch yoke mechanism 190a is to move the rollers by a third timing belt 192. The third timing belt 192 is driven by third roller position change motors 191a, so that the shift ejection roller pair 118 fixed to the third timing belt 192 moves in the main scanning direction.

### Second Modification of Shift Ejection Roller Pair 118 According to Present Embodiment

A description is given of a second modification of the conveyance position changer that changes the position of the shift ejection roller pair 118 in the main scanning direction.

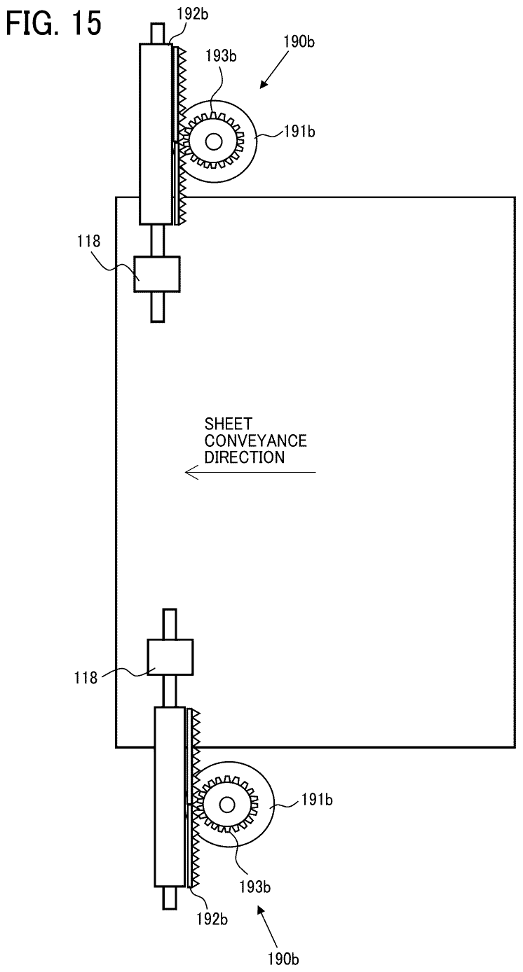

FIG. 15 is a diagram illustrating yet another position changing operation of a conveyance roller pair in the medium conveying mechanism. FIG. 15 illustrates a third scotch yoke mechanism 190b.

The third scotch yoke mechanism 190b is to cause a third roller position change motors 191b to drive pinion gears 193b and cause the pinion gears 193b to drive the rack gears 192b.

The shift ejection roller pair 118 is attached to the rack gears 192b. Accordingly, the third roller position change motors 191b drives and rotates to move the rack gears 192b linearly in the main scanning direction. Due to such a configuration, the shift ejection roller pair 118 is also moved in the main scanning direction.

### Sheet Conveyance Control Process Flow

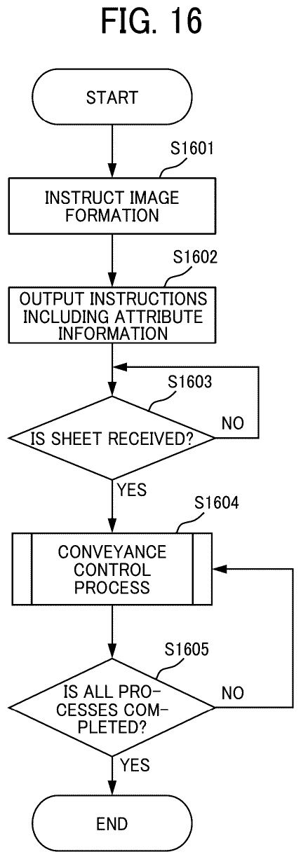

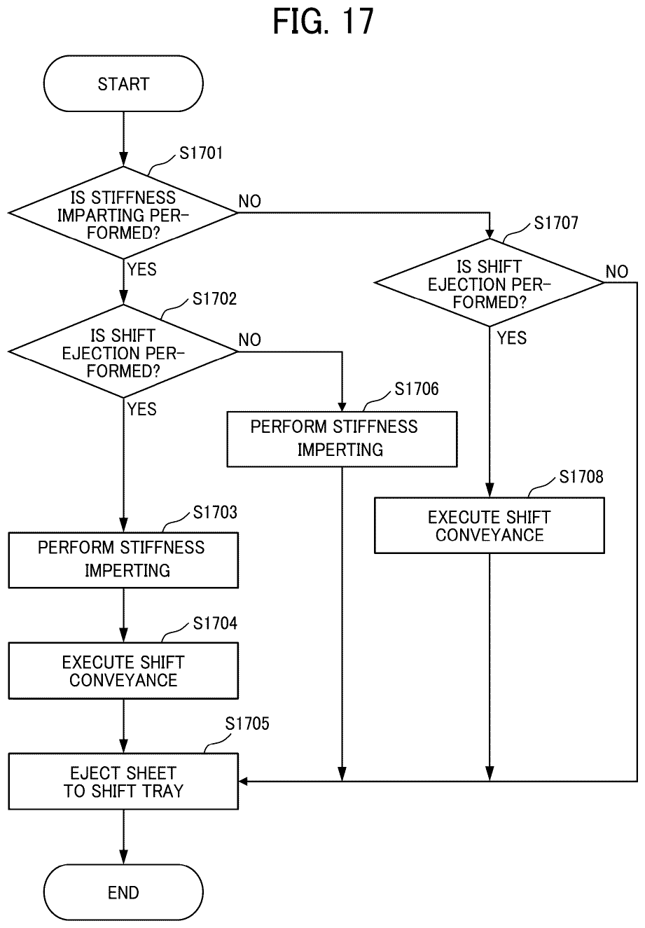

A description is given below of a flow of a conveyance control process that can be executed in the image forming system 1 according to the present embodiment, with reference to flowcharts of FIGS. 16 and 17.

FIG. 16 is a flowchart of a conveyance control process of the post-processing apparatus 10.

FIG. 17 is another flowchart of a conveyance control process of the post-processing apparatus 10.

The given post-processing operation described above is also performed together with the following conveyance control processing. Since the feature of the present embodiment is not processing that is linked to or caused by specific post-processing, the description of the post-processing is omitted, and only the flow of the conveyance control processing will be described.

First, as illustrated in FIG. 16, an image formation is instructed to the image formation controller 200 so that the image forming apparatus 20 performs the image forming process (step S1601). The instructions related to the post-processing operation with respect to the sheet P subjected to the image forming operation, together with the attribute information of the sheet P included in the image forming instruction in the image forming apparatus 20, are output by the post-processing controller 100 of the post-processing apparatus 10 (step S1602).

Then, the post-processing controller 100 determines whether the sheet P is received (step S1603). When the sheet P is not received (NO in step S1603), the post-processing apparatus 10 waits for reception of the sheet P until the sheet P is conveyed from the image forming apparatus 20 to the post-processing apparatus 10. When the sheet P is conveyed from the image forming apparatus 20 to the post-processing apparatus 10 and the sheet P is received in the post-processing apparatus 10 (YES in step S1603), the conveyance control process is executed so as to execute the post-processing notified in advance (step S1604).

Then, the post-processing controller 100 determines whether all of the given processes are completed together with the conveyance control process (step S1605). When the given processes are not completed (NO in step S1605), the post-processing controller 100 repeats the process until all of the given process of the post-processing operation is completed together with the conveyance control process (NO in step S1605). When all the processes are completed (YES in step S1605), the conveyance control process ends.

A description is given of the flow of the conveyance control process, with reference to the flowchart of FIG. 17.

First, the post-processing controller 100 determines whether a process of increasing the stiffness, that is, a “stiffness imparting” is to be performed based on the attribute information related to the sheet P received by the post-processing apparatus 10 (step S1701).

When the “stiffness imparting” is to be performed on the sheet P to be conveyed (YES in step S1701), the post-processing controller 100 then determines whether a shift ejection is to be performed on the sheet P (step S1702). When the shift ejection is to be performed (YES in step S1702), as described above, the stiffness imparting is performed (step S1703), then the shift conveyance is executed (step S1704), and the sheet P is ejected to the shift tray 134 (step S1705).

When the “stiffness imparting” is to be performed on the sheet P to be conveyed (YES in step S1701), and then the shift ejection is not to be performed (NO in step S1702), the stiffness imparting is performed (step S1706), and 02: No), the stiffening operation is executed (S1706) and the sheet P is ejected to the shift tray 134 (step S1705).

When the “stiffness imparting” is not to be performed on the sheet P to be conveyed (NO in step S1701), the post-processing controller 100 subsequently determines whether a shift ejection is to be performed on the sheet P (step S1707). When the shift ejection is to be performed (YES in step S1707), the shift conveyance is executed (step S1708), and the sheet P is ejected to the shift tray 134 (step S1705).

When the “stiffness imparting” is not to be performed on the sheet P to be conveyed (NO in step S1701), and then the shift ejection is not to be performed (NO in step S1707), the sheet P is conveyed and ejected to the shift tray 134 (step S1705).

As described above, the post-processing apparatus 10 according to the present embodiment can narrow (decrease) the intervals in the main scanning direction between the multiple rollers that convey the sheet P, and thus can perform the stiffness imparting on the sheet P without pressing the medium face. Accordingly, since the load applied to the medium face can be reduced, the damage on the image formed on a sheet is reduced, and the stacking failure of the sheet can be eliminated.

Further, since the stiffening amount is determined according to the distance by which the interval between the rollers is narrowed, the stiffening amount according to, for example, the size or thickness of the medium can be controlled. Accordingly, the stacking failure can be eliminated without being affected by the type of a medium.

As described above, the control method by the post-processing controller 100 described above is implemented by cooperation between hardware resources of a computer and a program as computer software. In other words, the control method may be executed by causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

The present disclosure is not limited to the above-described embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents. Such modifications and variations are included in the technical scope described in the appended claims.

### ASPECTS OF THE PRESENT DISCLOSURE

Aspects of the present disclosure are, for example, as follows.

### Aspect 1

In Aspect 1, a medium processing apparatus includes a conveyor including a conveyance roller pair, a conveyance position changer, and a controller. The conveyance roller pair conveys a sheet medium while nipping the sheet medium. The conveyance position changer changes a position where the conveyance roller pair nips the medium. The controller is configured to control operations of at least the conveyor and the conveyance position changer. The conveyance roller pair has rollers disposed facing each other in a main scanning direction orthogonal to a conveyance direction of the medium, and conveys the medium with the rollers nipping the vicinity of the end portion of the medium in the main scanning direction. The conveyance position changer changes a distance of the rollers of the conveyance roller pair facing each other based on the attribute information of the medium.

### Aspect 2

In Aspect 2, the medium processing apparatus according to Aspect 1 further includes a bending guide to restrict a direction in which the medium is bent in order to increase a stiffness of the medium. The bending guide is disposed on one side or the other side with a direction of a medium face of the medium as a target shaft. As the conveyance position changer reduces the distance between the rollers of the conveyance roller pair facing each other, the conveyance position changer bends the medium in a direction opposite to the position of the bending guide.

### Aspect 3

In Aspect 3, the medium processing apparatus according to Aspect 1 or 2 further includes multiple conveyors including the conveyor disposed in the conveyance direction of the medium. The controller is configured to stop a conveying operation of the conveyance roller pair at a timing at which the medium contacts the conveyance roller pair on a downstream side in the conveyance direction of the medium, and set a distance of the rollers of the conveyance roller pair on the downstream side in the conveyance direction based on the attribute information when a conveyance roller pair on an upstream side in the conveyance direction is continued.

### Aspect 4

In Aspect 4, the medium processing apparatus according to any one of Aspects 1 to 3 further includes multiple conveyors including the conveyor disposed in the conveyance direction of the medium. One of the multiple conveyors includes a shift conveyance roller pair to move the medium in the main scanning direction. The controller is configured to set an amount of movement of the shift conveyance roller pair in the main scanning direction based on the attribute information.

### Aspect 5

In Aspect 5, in the medium processing apparatus according to any one of Aspects 1 to 4, the conveyance position changer changes a distance between the rollers of the conveyance roller pair facing each other so that each conveyance roller pair nips an outside of an image forming area in which an image is formed on the medium as a conveyance target.

### Aspect 6

In Aspect 6, in the medium processing apparatus according to any one of Aspects 1 to 5, the attribute information is related to a size of the medium.

### Aspect 7

In Aspect 7, in the medium processing apparatus according to any one of Aspects 1 to 6, the attribute information is related to a thickness of the medium.

### Aspect 8

In Aspect 8, in the medium processing apparatus according to any one of Aspects 1 to 7, the attribute information is related to a stiffness of the medium.

### Aspect 9

In Aspect 9, an image forming apparatus includes an image forming device to form an image on a sheet medium, and the medium processing apparatus according to any one of Aspects 1 to 8.

### Aspect 10

In Aspect 10, an image forming system includes an image forming apparatus to form an image on a sheet medium, and the medium processing apparatus according to any one of Aspects 1 to 8 to perform an operation on the medium on which the image is formed by the image forming apparatus.

### Aspect 11

In Aspect 11, a medium processing apparatus includes a conveyor, a position changer, and circuitry. The conveyor conveys a sheet medium in a conveyance direction. The conveyor includes a roller pair having opposed rollers opposed to each other in a main scanning direction orthogonal to the conveyance direction. The roller pair nips an end portion of the sheet medium in the main scanning direction and convey the sheet medium in the conveyance direction. The position changer changes a position at which the roller pair nips the sheet medium to change an opposing distance between the opposed rollers of the roller pair in the main scanning direction. The circuitry is to control the conveyor and the position changer to change the opposing distance based on attribute information of the sheet medium.

### Aspect 12

In Aspect 12, the medium processing apparatus according to Aspect 11 further includes a bending guide to bend the sheet medium in one direction of a direction orthogonal to the conveyance direction of the sheet medium to increase a stiffness of the sheet medium. The bending guide is disposed on one side of a conveyance plane and an opposing plane opposite to the conveyance plane to convey the sheet medium, in the direction orthogonal to the conveyance direction. The circuitry is further to control the position changer to decrease the opposing distance of the roller pair to bend the sheet medium in the one side and an opposite side opposite to the one side of the conveyance plane where the bending guide is disposed.

### Aspect 13

In Aspect 13, the medium processing apparatus according to Aspect 11 or 12 further includes multiple conveyors including the conveyor. The multiple conveyors, including multiple roller pairs, include a downstream conveyor including a downstream roller pair, and an upstream conveyor including an upstream roller pair, the upstream conveyor being disposed upstream from the downstream conveyor in the conveyance direction. The circuitry is further to stop the first roller pair at a timing when the sheet medium contacts the downstream roller pair while driving the upstream roller pair, and set a distance between the opposed rollers of the downstream roller pair based on the attribute information.

### Aspect 14

In Aspect 14, the medium processing apparatus according to any one of Aspects 11 to 13 further includes multiple conveyors including the conveyor. One of the multiple conveyors includes a shift roller pair to move the sheet medium in the main scanning direction. The circuitry is further to set an amount of movement of the shift roller pair in the main scanning direction based on the attribute information.

### Aspect 15

In Aspect 15, in the medium processing apparatus according to any one of Aspects 11 to 14, the circuitry is further to control the position changer to change the opposing distance, to cause the roller pair to nip the end portion of the sheet medium outside an image forming area having an image on the sheet medium.

### Aspect 16

In Aspect 16, in the medium processing apparatus according to any one of Aspects 11 to 15, the circuitry is further to change the opposing distance based on the attribute information related to a size of the sheet medium.

### Aspect 17

In Aspect 17, in the medium processing apparatus according to any one of Aspects 11 to 16, the circuitry is further to change the opposing distance based on the attribute information related to a thickness of the sheet medium.

### Aspect 18

In Aspect 18, in the medium processing apparatus according to any one of Aspects 11 to 17, the circuitry is further to change the opposing distance based on the attribute information related to a stiffness of the sheet medium.

### Aspect 19

In Aspect 19, an image forming apparatus includes an image forming device to form an image on a sheet medium, and the medium processing apparatus according to any one of Aspects 11 to 18.

### Aspect 20

In Aspect 20, an image forming system includes an image forming apparatus to form an image on a sheet medium, and the medium processing apparatus according to any one of Aspects 11 to 18 to perform a process on the sheet medium on which the image is formed by the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

What is claimed is:

1. A medium processing apparatus comprising:
a conveyor to convey a sheet medium in a conveyance direction,
the conveyor including a roller pair having opposed rollers opposed to each other in a main scanning direction orthogonal to the conveyance direction, and
the roller pair to nip an end portion of the sheet medium in the main scanning direction and convey the sheet medium in the conveyance direction;
a position changer to change a position at which the roller pair nips the sheet medium to:
change an opposing distance between the opposed rollers of the roller pair in the main scanning direction; and
circuitry configured to control the conveyor and the position changer to change the opposing distance based on attribute information of the sheet medium.

2. The medium processing apparatus according to claim 1, further comprising a bending guide to bend the sheet medium in one direction of a direction orthogonal to the conveyance direction of the sheet medium to increase a stiffness of the sheet medium,
wherein the bending guide is disposed on one side of a conveyance plane and an opposing plane opposite to the conveyance plane to convey the sheet medium, in the direction orthogonal to the conveyance direction, and
the circuitry is further configured to control the position changer to decrease the opposing distance of the roller pair to bend the sheet medium in the one side and an opposite side opposite to the one side of the conveyance plane where the bending guide is disposed.

3. The medium processing apparatus according to claim 1, further comprising multiple conveyors including the conveyor,
wherein the multiple conveyors, including multiple roller pairs, include:
a downstream conveyor including a downstream roller pair; and
an upstream conveyor including an upstream roller pair, the upstream conveyor being disposed upstream from the downstream conveyor in the conveyance direction, and
the circuitry is further configured to:
stop the first roller pair at a timing when the sheet medium contacts the downstream roller pair while driving the upstream roller pair; and
set a distance between the opposed rollers of the downstream roller pair based on the attribute information.

4. The medium processing apparatus according to claim 1, further comprising multiple conveyors including the conveyor,
wherein one of the multiple conveyors includes a shift roller pair to move the sheet medium in the main scanning direction,
the circuitry is further configured to set an amount of movement of the shift roller pair in the main scanning direction based on the attribute information.

5. The medium processing apparatus according to claim 1,
wherein the circuitry is further configured to control the position changer to change the opposing distance, to cause the roller pair to nip the end portion of the sheet medium outside an image forming area having an image on the sheet medium.

6. The medium processing apparatus according to claim 1,
wherein the circuitry is further configured to change the opposing distance based on the attribute information related to a size of the sheet medium.

7. The medium processing apparatus according to claim 1,
wherein the circuitry is further configured to change the opposing distance based on the attribute information related to a thickness of the sheet medium.

8. The medium processing apparatus according to claim 1,
wherein the circuitry is further configured to change the opposing distance based on the attribute information related to a stiffness of the sheet medium.

9. An image forming apparatus comprising:
an image forming device to form an image on a sheet medium; and
the medium processing apparatus according to claim 1.

10. An image forming system comprising:
an image forming apparatus to form an image on a sheet medium; and
the medium processing apparatus according to claim 1 to perform a process on the sheet medium on which the image is formed by the image forming apparatus.
